(19) United States
(12) Patent Application Publication
(10) Pub. No.: US 2026/0112132 A1
(43) Pub. Date: Apr. 23, 2026

(54) NON-TRANSITORY MACHINE-READABLE MEDIUM FOR GENERATING XR SCENE USING WEB ENVIRONMENT OF MOBILE USER DEVICE AND PLAYBACK CORRECTION

(71) Applicant: LIMITED LIABILITY COMPANY "ADDON", MOSCOW (RU)

(72) Inventors: Dmitriy Viktorovich VETROV, Syktyvkar (RU); Sergey Alekseevich POPOV, s. Polyany (RU); Ivan Andreevich GIRIN, Moscow (RU); Kirill Vitalyevich BUROV, Moscow (RU)

(21) Appl. No.: 19/222,994

(22) Filed: May 29, 2025

(30) Foreign Application Priority Data
Oct. 17, 2024 (RU) 2024131171

(51) Int. Cl. G06T 19/00; G06F 3/0346; G06T 19/20

(52) U.S. Cl. CPC G06T 19/006; G06F 3/0346; G06T 19/20; G06T 2219/2004

(57) ABSTRACT

The technical solution relates to the field of information technology, more specifically, to methods and techniques for creating extended reality (XR) scenes. There is a need to ensure the ability to create reliable and stable XR applications that allow for stable and reliable generation of an XR scene regardless of the operating system of the mobile user device. The technical result achieved by implementing the claimed technical solution, in addition to implementing the product and/or method for its intended purpose, is to ensure the reliability and stability of generating an XR scene using the web environment of a mobile user device. In some other aspects, the technical result achieved by implementing the claimed technical solution is also an increase in the stability of the XR scene.

### FIELD OF INVENTION

The present invention relates to information technologies, particularly to methods and ways of creating extended reality scenes (XR scenes).

### DESCRIPTION OF THE RELATED ART

There are various known methods and ways of generating extended reality scenes using dedicated computer applications. Most typically, such applications provide program codes that allow the user to generate XR scenes within the frameworks of the applications themselves. However, such applications are not always cross-platform, that is, it is not always possible to generate the same XR scene using a plurality of heterogeneous mobile user devices. Also, most typically, in terms of the operating system, mobile user devices can be divided into mobile user devices with an open-source operating system and mobile user devices with a proprietary operating system. For example, but not limited to, the most in-demand devices at the time of this disclosure are mobile user devices running the Android® operating system (Google LLC, US), which is an open-source operating system, and mobile user devices running the iOS® operating system (Apple Inc., US), which is a proprietary operating system. At the same time, in most cases, ensuring cross-platform compatibility, i.e. adapting the program code to operate on different operating systems, is a non-trivial and time-consuming job, and therefore application developers are often forced to focus on adapting their application to a single operating system. This, in turn, causes inconveniences for users who are thus forced to choose mobile devices running the same operating system in order to share, for example, an XR application, which, in turn, limits, for example, the use of such an XR application in situations where the flow of users, and therefore of mobile user devices, is inconsistent and heterogeneous, such as, for example, during exhibition events.

However, patent document U.S. Ser. No. 11/328,491B2, published on May 10, 2022 (D1) discloses systems and methods for improving interaction between computers in systems for providing, displaying and/or hosting content that are supported or configured using devices, servers and/or platforms. The systems and methods disclosed in D1 provide a new structure that displays an XR interface. The XR panel is configured to visualize and automatically and progressively adjust the panel and/or the augmented reality (AR), virtual reality (VR) and/or mixed reality (MR) content based on dynamically determined and updated positioning of the viewing user. In addition, D1 indicates that the method can be implemented using a web environment. However, it provides no examples of how exactly a web environment can be used to generate an XR scene. At the same time, despite the fact that the use of a web environment to ensure cross-platform compatibility may appear to be an obvious choice for a person skilled in the art, such an approach is fraught with many problems due, among other things, but not limited to, to the fact that all WebXR applications require that the corresponding API of the operating system be used, while access to it form outside, i.e. at least from a web environment deployed in a browser, may be restricted, for example, by the proprietary operating system developed for no reason at all.

Therefore, there is a need in the field to enable the creation of reliable and stable XR applications that allow to generate stable and reliable XR scenes, regardless of the operating system running on the mobile user device.

The solution disclosed in D1 can be considered the closest prior art to the claimed invention.

### SUMMARY OF THE INVENTION

The technical problem to be solved by the claimed invention is to provide a product and/or a method and/or an implementation of said product or method that eliminate the drawbacks of the prior art and thus enabling reliable and stable cross-platform generation and/or playback of XR scenes that are independent of the operating system of the mobile user device. In some other aspects, an improved stability of XR scenes is also provided. Another technical problem to be solved by the claimed invention is to provide a product and/or a method and/or an implementation that expand the available technical means, namely methods for generating an XR scene.

The objective of the claimed invention, in addition to the product and/or method fulfilling their purpose, is to enable reliable and stable generation of XR scenes using the web environment of the mobile user device. In some aspects, the objectives also include the provision of an improved stability of XR scenes.

The objective of the present invention is achieved by 1. A non-transitory machine-readable medium containing a program code, which, when executed by at least one processor of at least one computer device, allows to perform a method for generating an XR scene, the method comprising at least the following steps: identifying the mobile user device; obtaining data for generating an XR scene and storing the obtained data in a cash memory of the mobile user device; generating a virtual part of the XR scene; obtaining coordinates of a real-world part of the XR scene; creating spatial anchors for anchoring the virtual part of the XR scene to the coordinates of the real-world part thereof; obtaining coordinates of the mobile user device and its position and/or spatial orientation and displaying the generated XR scene based on the obtained coordinates of the mobile user device and its position and/or spatial orientation; wherein only one API suitable for generating XR scenes is used to generate the XR scene; wherein, after the mobile user device has been identified, a program code is provided, if necessary, which, when executed by a processor of the mobile user device, at least allows to at least partially use the API suitable for generating XR scenes instead of the only one API suitable for generating XR scenes; and wherein, after the XR scene has been generated, additional data are obtained from at least a lidar of the mobile user device; wherein the playback of the virtual part of the XR scene is adjusted, if necessary, based on the data obtained from the accelerometer and the gyroscope of the mobile user device and the additional data obtained from the lidar of the mobile user device.

### BRIEF DESCRIPTION OF THE DRAWINGS

Exemplary embodiments of the present utility model are described in further detail below with references made to the attached drawings, included herein by reference:

FIG. 1 shows an exemplary diagram of method 100 for generating an XR scene.

FIG. 2 shows an exemplary diagram of system 200 for generating an XR scene.

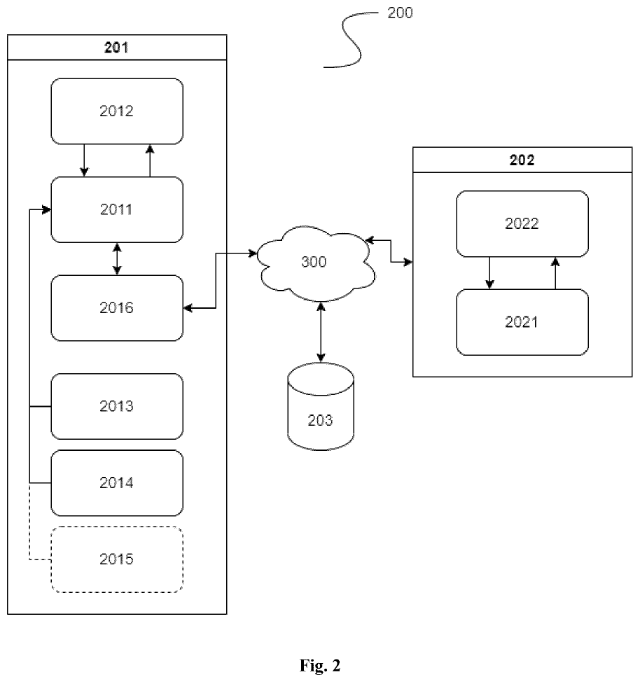

### DETAILED DESCRIPTION OF THE PREFERRED EMBODIMENTS

According to a preferred embodiment of the present invention, there is provided a method for generating an XR scene, executed by at least one processor of at least one mobile user device, the method comprising at least the following steps: identifying the mobile user device; obtaining data for generating an XR scene and storing the obtained data in a cash memory of the mobile user device; generating a virtual part of the XR scene; obtaining coordinates of a real-world part of the XR scene; creating spatial anchors for anchoring the virtual part of the XR scene to the coordinates of the real-world part thereof; obtaining coordinates of the mobile user device and its position and/or spatial orientation and displaying the created XR scene based on the obtained coordinates of the mobile user device and its position and/or spatial orientation; wherein only one API suitable for generating XR scenes is used to generate the XR scene; and wherein, after the mobile user device has been identified, a program code is provided, if necessary, which, when executed by a processor of the mobile user device, at least allows to at least partially use an API suitable for generating XR scenes instead of the default API.

According to an exemplary embodiment of the present invention, there is provided a method characterized in that the program code is provided through an app distribution system.

According to an exemplary embodiment of the present invention, there is provided a method characterized in that, after the XR scene has been generated, data are obtained from at least an accelerometer and a gyroscope of the mobile user device in order to determine, in sequence, its position and/or spatial orientation; wherein the playback of the virtual part of the XR scene is adjusted, if necessary, based on the data obtained from the accelerometer and the gyroscope of the mobile user device.

According to an exemplary embodiment of the present invention, there is provided a method characterized in that, after the XR scene has been generated, additional data are obtained from at least a lidar of the mobile user device; wherein the playback of the virtual part of the XR scene is adjusted, if necessary, based on the data obtained from the accelerometer and the gyroscope of the mobile user device and the additional data obtained from the lidar of the mobile user device.

According to an exemplary embodiment of the present invention, there is provided a method characterized in that in case the mobile user device, which is a first mobile user device, does not have a lidar, the lidar data are obtained using a second mobile user device, which is equipped with a lidar.

According to an exemplary embodiment of the present invention, there is provided a method characterized in that the spatial anchors are used to generate an environment mask.

According to another preferred embodiment of the present invention, there is provided a device for generating an XR scene, the device comprising at least one or more processors; a transceiver; a means for determining the device's position and/or spatial orientation; a memory that stores a program code which, when executed by the at least one processor, allows to perform any of the disclosed methods for generating an XR scene.

According to another preferred embodiment of the present invention, there is provided a system for generating an XR scene, the system comprising at least a server device that is at least adapted to provide data for generating an XR scene to at least one mobile user device, and a mobile user device, which is represented by any of the disclosed mobile user devices, that is at least adapted to receive said data for generating an XR scene and to generate an XR scene based on the received data.

According to another preferred embodiment of the present invention, there is provided a machine-readable storage medium containing a program code, which, when executed by at least one processor of at least one computer device, allows to perform any of the disclosed methods for generating an XR scene.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

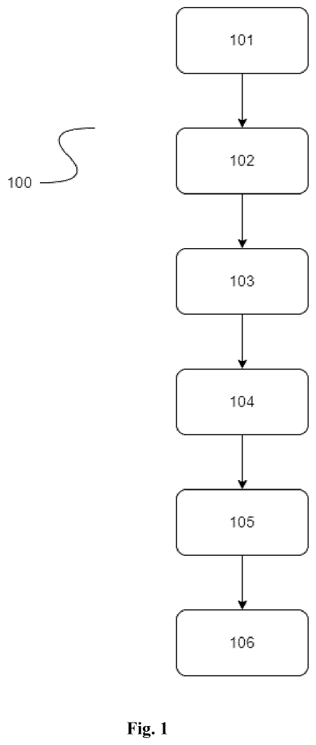

FIG. 1 shows an exemplary diagram of method 100 for generating an XR scene. According to a preferred embodiment of the present invention, there is provided a method 100 for generating an XR scene, executed by at least one processor 2011 of at least one mobile user device 201, the method comprising at least the following steps: identifying 101 the mobile user device 201; obtaining 102 data for generating an XR scene and storing the obtained data in a cash memory of the mobile user device 201; generating 103 a virtual part of the XR scene; obtaining 104 coordinates of a real-world part of the XR scene; creating 105 spatial anchors for anchoring the virtual part of the XR scene to the coordinates of the real-world part thereof; obtaining 106 coordinates of the mobile user device 201 and its position and/or spatial orientation and displaying the created XR scene based on the obtained coordinates of the mobile user device 201 and its position and/or spatial orientation; wherein only one API suitable for generating XR scenes is used to generate the XR scene; and wherein, after the user's web browser has been identified, a program code is either provided or not provided, which, when executed by a processor of the mobile user device 201, at least allows to utilize the API that has been used to generate the XR scene instead of the default API. Most typically, a mobile user device 201 can be a mobile user device 201 running the Android® operating system (Google LLC, US), which is an open-source operating system, or a mobile user device 201 running the iOS® operating system (Apple Inc., US), which is a proprietary operating system. Most typically, a mobile user device 201 powered by Android™ contains a program code, which, when executed by at least one processor of said mobile device 201, prompts the processor to implement a web environment that can be accessed through a web browser installed on the mobile user device 201, which for Android®-powered mobile user devices 201 is typically, a Chromium®-based web browser (Google LLC, US). Most typically, a mobile user device 201 powered by iOS® contains a program code, which, when executed by at least one processor of said mobile device 201, prompts the processor to implement a web environment that can be accessed through a web browser installed on the mobile user device 201, which for iOS®-powered mobile user devices 201 is typically, a Safari®-based web browser (Apple Inc., US). In addition, but not limited to, most typically, in step 101, the web browser is used to generate a query to the server 202 that stores XR scenes to provide data for generating an XR scene, wherein, usually, such a query, most typically, includes at least the data about the mobile user device 201, particularly, data regarding the operating system of the mobile user device 201, which, therefore, are identification data of the mobile user device 201, and, correspondingly, said server 202, most typically, is adapted to extract said identification data to identify the mobile user device 201, which is, most typically, one of the Android®-powered mobile user devices 201 or the iOS®-powered mobile user devices 201. In addition, but not limited to, when the identification data of the mobile user device 201 are obtained, it becomes possible to provide data to generate the XR scene. In addition, but not limited to, the data used to generate the XR scene, usually, include at least scripts for generating an XR scene using a suitable API, 3D models to be used in the XR scene to be generated, and, optionally, textures and/or skyboxes associated with the 3D models. Accordingly, but not limited to, Android®-powered devices 201 are provided with scripts for generating an XR scene using the ARCore® API (Google LLC, US), which is, therefore, a suitable API, while, but not limited to, iOS®-powered devices are provided with scripts for adjusting the generated XR scene using the ARKit® API (Apple Inc., US), which is, therefore, a default API. However, but not limited to, if the device is identified as an iOS®-powered device, it is additionally provided with scripts for generating an XR scene using the ARCore® API, wherein the program code is provided, for example, through an app distribution system, such as, for example, but not limited to, App Store®, and wherein the program code thus provided, when executed by the processor of the device 201, which uses the default API, at least allows at least partial use of the API that is suitable for generating an XR scene instead of the default one. Therefore, more specifically, but not limited to, when generating an XR scene on an iOS®-powered mobile device 201, at least partial use of ARCore®, i.e., of a suitable API that is utilized on Android®-powered devices 201, instead of the default ARKit® will be ensured. At the same time, but not limited to, the default ARKit® may still be utilized to adjust the positioning and playback of objects in the XR scene, but only to the extent of using the lidar of the iOS®-powered mobile device 201. It should be obvious to a person having ordinary skill in the art that specific operating systems and specific APIs referred to herein are meant as non-limiting examples. Accordingly, ARCore® is not the only suitable API, nor is ARKit® necessarily used by default; the reverse is also possible, where ARKit® is preferably used to generate the XR scene, while ARCore® is utilized in a limited fashion, only to activate certain components of the device that uses this API by default. Therefore, but not limited to, mobile devices 201 running different operating systems should rather be considered as first mobile devices 201 and second mobile devices 201, while a corresponding API, which is suitable for generating XR scenes, and a default API should rather be considered as a first API and a second API.

In addition, but not limited to, the data for generating the XR scene obtained in step 102 are stored in the cash memory of user device 201, thus allowing at least partial generation of the XR scene using at least one processor 2011 of the device 201, which ensures the required stability of the XR scene in case the device 201 does not receive sufficient radio signal and cannot receive data from server 202 or the reception of data is significantly impeded. In addition, but not limited to, in step 103, virtual components of the XR scene are pre-rendered, such as, for example, but not limited to, virtual objects either having or not having textures and/or skyboxes, which will be used later when the XR scene will be diplayed using device 201. In addition, but not limited to, in step 104, the coordinates of the real-world part of the XR scene are obtained, particularly, but not limited to, the surroundings are analyzed and the coordinates of the virtual objects from step 103 are calculated; wherein, for example, but not limited to, a lidar of mobile user device 201 can be used to obtain more detailed information about the surrounding space. In addition, but not limited to, in step 105, at least spatial anchors for anchoring the virtual part of the XR scene to the calculated coordinates of the real-world part thereof are created; wherein, for example, but not limited to, the calculated coordinates of the objects in the virtual part of the XR scene can be adjusted. In addition, but not limited to, in step 106, the spatial coordinates of the mobile user device 201, as well as its position and/or spatial orientation, including, but not limited to, at least its tilt angle with respect to the horizon and/or surfaces of the real-world part of the XR scene and so on, are obtained, after which the objects in the virtual part of the XR scene are displayed using the mobile user device 201, wherein said objects are anchored to the real-world part of the XR scene using the spatial anchors obtained in step 105, and wherein, but not limited to, the generated XR scene is further adjusted after receiving data from the sensors of mobile user devices 201. In addition, for example, but not limited to, after the XR scene has been generated, data are obtained from at least an accelerometer 2013 and a gyroscope 2014 of the mobile user device 201 in order to determine, in sequence, its position and/or spatial orientation; wherein the playback of the virtual part of the XR scene is adjusted, if necessary, based on the data obtained from the accelerometer 2013 and the gyroscope 2014 of the mobile user device 201.

Therefore, but not limited to, it can be ensured that one and the same XR scene is created and displayed on a plurality of heterogeneous mobile user devices 201, which, accordingly, provides a number of advantages. For example, but not limited to, it becomes possible to utilize a second mobile user device 201 that is equipped with a lidar, which would not have enabled the playback of the XR scene on first mobile user devices 201 that are not equipped with a lidar if its default API were used. Therefore, when a common web environment is provided for generating, displaying and adjusting XR scenes, then it becomes possible, after an XR scene has been generated, to obtain data from at least the lidar of a second mobile user device 201, which, for example, but not limited to, may enable adjustment of the playback of the virtual part of the XR scene based not only on the data obtained from the accelerometer 2013 and the gyroscope 2014 of first and second mobile devices 201, but also on the additional data obtained from the lidar 2015 of at least one second mobile user device 201 that is equipped with a lidar 2015. Furthermore, but not limited to, when said mobile user device 201, which is the first mobile user device 201, is not equipped with a lidar, then lidar data for generating the XR scene on the first mobile user device 201 are obtained by means of a second mobile user device 201 that is equipped with a lidar 2015. Therefore, there may be provided an adjustment subsystem, in which a second mobile user device 201 that is equipped with a lidar 2015, can be used on an ongoing basis, which, for example, but not limited to, exchanges data with the server 202, thus providing a continuous update and adjustment of the generated XR scene for a plurality of mobile user devices 201 involved at once. To achieve this, for example, but not limited to, said spatial anchors are used to generate an environment mask, which is at least partially stored by means of the mobile user device 201, wherein such an environment mask is generated in advance using a second mobile user device 201 that is equipped with a lidar 2015, and wherein, but not limited to, the generated environment mask is then continuously transmitted, which makes it possible to use lidar data for calculating the coordinates of virtual objects, even if the mobile user device 201 is not equipped with a lidar. Alternatively, but not limited to, the environment masks that have been obtained in this way can be stored in the memory of server 202 and/or database 203 to be used by a plurality of devices 201 thus eliminating the need of the ongoing use of the device 201 equipped with lidar 2015. At the same time, a second mobile user device 201 can act as said server 202 functioning as a means of distribution of the environment mask, thus distributing the environment mask and/or data from lidar 2015 to a plurality of first devices 201 via a data exchange network 300. In this way, but not limited to, improved accuracy and stability of the generated XR scene can be achieved.

Therefore, but not limited to, according to another preferred embodiment of the present invention, there is provided a device 201 for generating an XR scene, the device comprising at least one or more processors 2011; a transceiver 2016; a means 2013, 2014, 2015 for determining the device's position and/or spatial orientation; a memory 2012 that stores a program code which, when executed by the at least one processor 2011, allows to perform any of the disclosed methods 100 for generating an XR scene. In addition, but not limited to, the transceiver 2016 enables communication between the device 201 and other devices 201, as well as with the server 202, via a data exchange network 300, which allows to form a system 200 for generating an XR scene, the system comprising therefore at least a server device 202, which, in turn, also comprises at least a processor 2021 and a memory 2022 that stores procedures, codes, and databases 203, which at least provide data for generating an XR scene to at least one mobile user device 201, and a mobile user device 201, which is represented by any of the disclosed mobile user devices 201, that is at least adapted to receive said data for generating an XR scene and to generate an XR scene based on the received data. Therefore, but not limited to, there is also provided a machine-readable storage medium containing a program code, which, when executed by at least one processor of at least one computer device, allows to perform any of the disclosed methods for generating an XR scene.

In addition, in case the device for generating an XR scene is a mobile user device, such a mobile user device is, most typically, a portable computer device, such as, for example, but not limited to, a laptop, a netbook, a tablet, a smartphone, etc., and may, optionally, also include an output device, such as, for example, a display, which may be a sensor display and server therefore as an input/output device. However, it should be obvious to a person having ordinary skill in the art that the generated XR scene can be displayed not only on an output device, but also using an add-on output device, such as, for example, but not limited to, a display, a VR headset or glasses, an AR headset or glasses, etc. In addition, but not limited to, the external output device and its spatial position can be tracked so as to ensure that the XR scene is correctly displayed on it.

Thus, preferably, but not limited to, according to the present disclosure, there may be provided a computer device. Most typically, said computer device comprises at least one or more processors, and a memory that stores a corresponding program code as disclosed above. At the same time, said computer device can act as a corresponding server of a corresponding system that, therefore, also comprises at least one or more processors and a memory, which are, therefore, essentially identical to the processor(s) and the memory of the computer devices disclosed above, respectively. For example, but not limited to, the memory (computer-readable medium) may comprise a non-volatile memory (NVRAM); a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other magnetic drive; and any other medium capable of storing and encoding the necessary information. In addition, but not limited to, the memory comprises a computer-readable medium based on the computer memory, either volatile or non-volatile, or a combination thereof. In addition, but not limited to, exemplary hardware devices include solid-state drives, hard disk drives, optical disk drives, etc. For instance, but not limited to, the computer-readable medium (memory) is not a temporary memory (i.e., a permanent, non-transitive memory), and therefore it does not contain a temporary (transitive) signal. In addition, but not limited to, the memory may store an approximate environment in which, using computer commands or codes, including those stored in the server's memory, any of the previously disclosed computer procedures, executed by the processor of the computer device, can be performed. In addition, but not limited to, the computer device, if it is not a thin client, contains one or more processors that are designed to execute computed commands or codes that are stored in the device's memory in order to perform the disclosed procedures. In addition, but not limited to, the server, essentially, can be similar to the computer device, if it is not a thin client, and, therefore, contain one or more processors that are designed to execute computed commands or codes that are stored in the server's memory in order to perform the disclosed procedures. In addition, but not limited to, any system disclosed herein may further comprise a database 203. Said database may be, but not limited to, a hierarchical database, a network database, a relational database, an object database, an object-oriented database, an object-relational database, a spatial database, a combination of two or more said databases, etc. In addition, but not limited to, the database at least stores data, parameters, raw data, marked-up data, modified data, machine learning models, and other information in its memory or a suitable memory of another computer device that is connected to any of the disclosed computer devices and/or the server, which may be, but not limited to, a memory that is similar to any of the disclosed memories, and which can be accessed via the server. In addition, but not limited to, there is provided a server, which, in addition to the functions mentioned above, stores and facilitates the execution of computer-readable commands and codes disclosed herein, which, accordingly, won't be described again. In addition, but not limited to, the server, in addition to the functions mentioned above, is capable of controlling the data exchange in the system. In addition, but not limited to, data exchange within the disclosed system is performed with the help of one or more data exchange networks 300. In addition, but not limited to, data exchange networks may include, but not limited to, one or more local area networks (LAN) and/or wide area networks (WAN), or may be represented by the Internet or Intranet, or a virtual private network (VPN), or a combination thereof, etc. In addition, but not limited to, the server is further capable of providing a virtual computer environment for the components of the system to interact with each other. In addition, but not limited to, the data exchange network is used to ensure interaction between the computer device, the server, optionally, the database, and, optionally, the systems mentioned above and other systems. In addition, but not limited to, the non-thin client computer device and/or server may be connected to the database directly, using wired or wireless communication methods, which are known in the art and therefore are not described in further detail, or, but not limited to, the database may be implemented in the memory of any computer device, including the server. In addition, but not limited to, a suitable non-thin client computer device can act as a system server for other computer devices, which are thin clients. In addition, but not limited to, most typically, the components of the computer devices disclosed herein and the server components are interconnected, including though some kind of data bus.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A non-transitory machine-readable medium containing a program code, which, when executed by at least one processor of at least one computer device, allows to perform a method for generating an XR scene, the method comprising at least the following steps:
identifying the mobile user device;
obtaining data for generating an XR scene and storing the obtained data in a cash memory of the mobile user device; generating a virtual part of the XR scene;
obtaining coordinates of a real-world part of the XR scene;
creating spatial anchors for anchoring the virtual part of the XR scene to the coordinates of the real-world part thereof;
obtaining coordinates of the mobile user device and its position and/or spatial orientation and displaying the generated XR scene based on the obtained coordinates of the mobile user device and its position and/or spatial orientation;
wherein only one API suitable for generating XR scenes is used to generate the XR scene;
wherein, after the mobile user device has been identified, a program code is provided, if necessary, which, when executed by a processor of the mobile user device, at least allows to at least partially use the API suitable for generating XR scenes instead of the only one API suitable for generating XR scenes; and
wherein, after the XR scene has been generated, additional data are obtained from at least a lidar of the mobile user device;
wherein the playback of the virtual part of the XR scene is adjusted, if necessary, based on the data obtained from the accelerometer and the gyroscope of the mobile user device and the additional data obtained from the lidar of the mobile user device.

2. The medium of claim 1, characterized in that the program code is provided through an app distribution system.

3. The medium of claim 1, characterized in that, after the XR scene has been generated, additional data are obtained from at least a lidar of the mobile user device; wherein the playback of the virtual part of the XR scene is adjusted, if necessary, based on the data obtained from the accelerometer and the gyroscope of the mobile user device and the additional data obtained from the lidar of the mobile user device.

4. The medium of claim 3, characterized in that in case the mobile user device, which is a first mobile user device, does not have a lidar, the lidar data are obtained using a second mobile user device that is equipped with a lidar.

5. The medium of claim 1, characterized in that the spatial anchors are used to generate an environment mask.

6. The medium of claim 2, characterized in that the spatial anchors are used to generate an environment mask.

7. The medium of claim 3, characterized in that the spatial anchors are used to generate an environment mask.

8. The medium of claim 4, characterized in that the spatial anchors are used to generate an environment mask.
